(19) United States
(12) Patent Application Publication
(10) Pub. No.: US 2017/0121442 A1
(43) Pub. Date: May 4, 2017

(54) Method for Obtaining a Hybrid Latex and Use Thereof in Hydrophobic and Superhydrophobic Coatings

(71) Applicants: Centro de Investigacion en Polimeros, S.A. de C.V., Acolman (MX); Georgia Southern University Research and Service Foundation, Inc., Statesboro, GA (US)

(72) Inventors: Julian Masasue GALVAN-MIYOSHI, Acolman (MX); Fabio PEZZOTTI-ROBLETO, Acolman (MX); Weihua MING, Statesboro, GA (US); Quanyuan ZHANG, Statesboro, GA (US)

(21) Appl. No.: 15/314,287

(22) PCT Filed: May 27, 2015
(86) PCT No.: PCT/IB2015/053987

§ 371 Date: Nov. 28, 2016

(30) Foreign Application Priority Data
May 28, 2014 (MX) MX/A/2014/006426

(51) Int. Cl. C08F 283/12; C09D 143/04

(52) U.S. Cl. CPC C08F 283/124; C09D 143/04; C08K 3/36

(57) ABSTRACT

The present invention relates to a siliconized hybrid latex that consists of a polysiloxane methacrylic copolymer of the formula (I), starting with at least one methacrylic monomer that is partially soluble in water, and at least one functionalised silicone-based macromonomer that is insoluble in water and highly hydrophobic, and to the use of said latex in a water-based formula, free of fluorinated compounds, generating highly hydrophobic or superhydrophobic surfaces with self- or easy-cleaning properties.

### FIELD OF THE INVENTION

The present invention is related to the chemical industry and more specifically with the synthesis of polymers useful in the field of paints and coatings.

### BACKGROUND OF THE INVENTION

Generally surfaces are protected by application of specific coatings enduring its lifespan and protecting the substrate from environmental agents such as moist, fungi, bacteria and dirt. The deposition of these pollutants is caused over time by airborne particles which adhere to the coated surfaces, which is necessary to eliminate by washing with wet rags, brooms, brushes, etc. requiring time and effort.

There is a great number of patents applications describing coatings with a superhydrophobic effect; however most of them use hydrophobic components for their preparation limiting the application to solvent borne coatings CN102002319A (Haowei Yang et. al. 2010), CN101928517A (Lingjuan Zhang et. al. 2010), US20120107581A1 (Simpson et. al. 2012)) whose compositions have increasingly restrictions due to new environmental regulations.

In the patent application US20120107581A1 is described an optically transparent coating doped with nanoparticles embedded in either a fluoride or organic solvent such as perfluoro n-dibutylamine, perfluoro-2-butyl tetrahydrofuran, acetone or propyl acetate in concentrations over 90% where hydrophobically modified silica nanoparticles are dispersed. The resin used to fix these nanoparticles does not present any characteristic feature to which hydrophobicity can be granted. These resins are employed at extremely low solid concentration (0.1-0.7 weight percent) and they are only used as medium for the adhesion of the nanoparticles to the substrate. Higher concentrations of the resin in the composition decreases its hydrophobic properties as the hydrophobic nanoparticles are completely covered by the resin.

In the patent application CN102002319A hydrophobic coating is described employing a resin based on poly-phenyl silsesquioxane embedded in an organic solvent such as ethanol, propanol, isopranol, butanol, isobutanol, diacetone alcohol, acetone, methyl ethyl ketone, methyl isobutyl ketone, toluene, xylene, dimethyl carbonate, ethyl acetate, propyl acetate, butyl acetate, etc. mixed with a dispersion of inorganic particles such as silica, titanium dioxide, aluminum oxide, zirconium, zinc oxide, calcium carbonate and kaolin or talcs. The superhydrophobic effect is achieved by the poly-silsesquioxane polymer therefore the use of organic solvents is mandatory.

In the patent application US2009136741A1, (Zhang Minjuan et. al. 2009) a process for obtaining a superhydrophobic surface is described by mixing surface modified silica nanoparticles with a transparent film forming resin. Silica nanoparticles are hydrophobically modified by means of hydrophobic therefore the use of organic solvents such as toluene or thinner is necessary for their dispersion. Subsequently the film forming resin has to be solvent borne or compatible with the solvent borne dispersion.

In the patent application US20090064894A1 (Baumgart et. al. 2009) the hydrophobic effect is described by means of application of an aerosol dispersion containing hydrophobically modified silica nanoparticles at 10% concentration stabilized with commercial emulsifiers. These particles only exhibit their hydrophobic effect for about 4 months due to the lack of a resin or polymer for their adhesion to the substrate. Alternatively a perfluoro alkyl substituted acrylic polymer, aminofunctional siloxanes, beeswax, or a trimethylsilyl end capped siloxane can be applied as a top coat to increase the endurance of the hydrophobic effect. Any system containing fluoride polymers as hydrophobic enhancers will increase the final coating's price.

The patent application US20100326699A1 (Greyling, 2010) relates to a coating including a siloxane hydrocarbon copolymer including a siloxane moiety corresponding to an organofunctional siloxane oligomer or polymer and a hydrocarbon moiety corresponding to a hydrocarbon based oligomer or polymer, mixed with bifunctional polydimethylsiloxane (PDMS) macromonomer surface modified nanosilica particles. These components, the resin and the nanoparticles, are finally mixed with an epoxy-based polymeric concrete composition for obtaining a high voltage insulator. Both the resin and the modified nanoparticles must migrate to the coating's surface before the concrete is completely cured in order to achieve the hydrophobic effect.

A hydrophobic coating composed by an acrylic-PDMS copolymer synthesized via emulsion and miniemulsion polymerization is described in the article “Correlation of Silicone Incorporation into Hybrid Acrylic Coatings with the Resulting Hydrophobic and Thermal Properties” (Rodriguez, et al, Macromolecules, 41, 8537-8546 2008) however the concentration of PDMS incorporated in the copolymer is not greater than 20% of the total monomer content and the contact angles reported are relatively low (<110°) corresponding to a hydrophobic coating and not a superhydrophobic coating.

The polymerization via emulsion polymerization of highly hydrophobic monomers has been achieved using cyclodextrins (Rimmer S, Tattersall P. Polymer 40, 5729-5731, 1999 y Lau W. Macromolecules Symposium, 182, 283-9, 2002) as carriers for monomer transport from the droplets to the polymer micelles.

Therefore there is a need to develop high performance, functional and environmentally friendly products such as waterborne products with very low VOC and minimum requirement of organic solvents with hydrophobic or superhydrophobic with self-cleaning properties.

### OBJECTS OF THE INVENTION

One object of the present invention is to obtain a hybrid silicone latex formed by a methacrylic—polysiloxane copolymer containing at least one partially water soluble methacryilic monomer and at least one silicone macromonomer insoluble in water.

Another object of the invention is to obtain a waterborne coating composition with hydrophobic effect and easy cleaning properties.

Further, another object of the invention is to obtain a coating composition that can be applied either by deposition, aspersion or spin coating.

Another object of the invention is to obtain afore mentioned coating composition being able to form a film at standard pressure and humidity conditions at 40° C.

Yet another object is to obtain a fluoride-free waterborne coating composition with a superhydrophobic effect.

Further objectives and advantages will become apparent from the following specification in connection with the accompanying non-limiting examples.

### BRIEF DESCRIPTION OF THE INVENTION

The present invention contemplates three different embodiments; the first embodiment exhibits the synthesis of a hybrid silicone latex, synthesized by means of at least a partially water soluble methacrylic monomer and at least one functionalized silicone macromonomer to obtain a hybrid silicone latex with the following general formula:

wherein R is either C1 to C4 alkyl chain or hydrogen and R₁ is

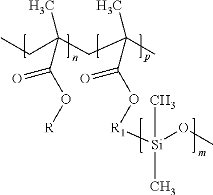

either C2 to C4 alkyl chain.

The second embodiment contemplates an easy cleaning hydrophobic coating composition based on the hybrid silicone latex described in the first embodiment, previously dispersed in water at concentrations between 0.5 and 15 weight percent based on the total weight of the components.

The third embodiment comprises a self cleaning superhydrophobic coating composition based on the hybrid silicone latex described in the first embodiment and surface modified fumed silica nanoparticles by means of an organosilane.

These three embodiments have a single general inventive concept comprising the hybrid silicone latex, synthesized by means of at least a partially water soluble methacrylic monomer and at least one water insoluble functionalized silicone macromonomer without the use of cosolvents, stabilizing agents or hydrophobes commonly used in emulsion or miniemulsion polymerization of highly hydrophobic or water insoluble monomers (Asua, J. M. Progr

### BRIEF DESCRIPTION OF THE DRAWINGS

FIG. 1: Transmission Electron Micrograph of the hybrid silicone latex of the invention. The scale bar represents 200 nm.

FIG. 2: Water droplet photography over a hydrophobic surface obtained with a coating composition of the present invention.

FIG. 3: Scanning Electron Micrograph of the surface of a superhydrophobic film obtained from the composition of the hybrid silicone latex and modified nanoparticles of the present invention. The scale bar represents 1.0 μm. Magnification is 20,000×.

FIG. 4: Water droplet photography over a superhydrophobic surface obtained with a coating composition of the present invention.

### DETAILED DESCRIPTION OF THE INVENTION

Self cleaning property is described as the ability to remove pollutants from a surface by means of a fluid stripping, generally water. The self cleaning mechanism is based either on the high repellency exhibited between the surface and the pollutants or the chemical degradation of pollutants when in contact with the surface. The present invention is based on the principle of superhydrophobicity observed in the leaves of the Lotus flower, considered a symbol of purity thanks to the capacity of staying clean by removing dirt particles from the surface with the single action of running water. The term superhydrophobic refers to very high water repellency obtained by the combination of the appropriate surface chemistry and an adequate roughness. The hydrophobicity of a surface is measured by the contact angle between a water droplet and the surface. Teflon®, a highly repellent material, exhibits a contact angle of 120° when applied to a smooth surface. Higher contact angles up to 176° can be achieved when applied to a surface with the appropriate roughness. A surface is considered to be superhydrophobic when the contact angle is greater than 130° and the slip angle, described as the necessary inclination angle for a water droplet to roll over the surface, is less than 20°. Other parameters normally measured for characterizing hydrophobicity in surfaces or coatings are the advancing (□_{A}) and receding angles (□_{R}). When the volume of a droplet in contact with a surface increases, the contact angle increases to reach a maximum in which static and dynamic friction forces are overcomed and steady progress of the solid-liquid interface is achieved. This is known as the advancing angle □_{A}.

When the volume of water decreases, the same phenomenon occurs obtaining a minimum contact angle known as the receding angle □_{R}. The hysteresis (□□) is the normally defined as the difference between both angles □□=□_{A}−ε_{R}.

The present invention relates in its first embodiment to the synthesis of a hybrid silicone latex, containing a methacrylic-polysiloxane copolymer with the following general formula:

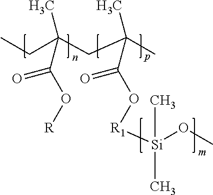

wherein R is either C₁ to C₄ alkyl chain or hydrogen and R₁ is either C₂ to C₄ alkyl chain.

The methacrylic-polysiloxane copolymer is obtained by synthesis of at least one partially water soluble methacrylic monomer and at least one water insoluble functionalized silicone macromonomer.

The preferred partially water soluble methacrylic monomer has the following general formula:

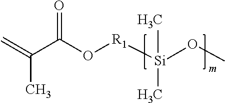

wherein R is either C₁ to C₄ alkyl chain or hydrogen.

The partially water soluble methacrylic monomer is selected from the non-limiting group consisting of butyl methacrylate, methyl methacrylate, methacrylic acid or mixtures thereof. Methyl methacrylate, butyl methacrylate or mixtures thereof are preferred.

The preferred water insoluble functionalized silicone based macromonomer has the following general formula:

wherein R₁ is either

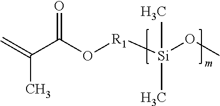

The water insoluble [symbol] ased macromonomer contains a methacrylic functionality and a molecular weight between 3000 and 15000 g/mol, preferably between 5000 and 10000 g/mol. The functionalized silicone based macromonomer is preferably polydimethylsiloxane PDMS.

The weight ratio between the water insoluble silicone macromonomer and the partially water-soluble methacrylic monomer is preferably between 1:9 and 7:3. The methacrylic monomer content is between 8 and 18 weight percent based on the total weight of components in the emulsion, wherein emulsion is defined as the whole composition of the hybrid silicone latex or monomer droplets dispersed in water.

The hybrid silicone latex of the first embodiment of the invention is obtained via a miniemulsion polymerization method from a mixture containing water, at least one partially water soluble methacrylic monomer, at least one water-insoluble functionalized silicone macromonomer, at least one emulsifier and without the use of cosolvents, stabilizing agents or hydrophobes commonly used in miniemulsion polymerization of water insoluble monomers (Asua, J. M. Progress in Polymer Science, 27, 1283-1346, 2002).

The mixture is emulsified by means of an ultrasound probe to form a dispersion of monomer droplets in water wherein the miniemulsion polimerizarization reaction is carried out; the droplets are stabilized by the components of the composition without the use of stabilizing agents or hydrophobes commonly used in miniemulsion polymerization.

The emulsifiers used in this invention for stabilization of the monomer droplets and polymer micelles may be ionic, non-ionic or mixtures thereof. Suitable emulsifiers include but are not limited to sodium dodecyl sulfate, sodium dodecylbenzene sulphonate, ammonium salt of nonylphenol ether, or mixtures thereof. Sodium dodecyl sulfate is preferred. The emulsifier concentration is between 0.8 and 2 weight percent, preferably between 1.0 and 1.5 weight percent based on the total weight of the components of the emulsion.

Prior to the polymerization the mixture is emulsified with an ultrasound probe to attain monomer droplets of 50 nm to 1000 nm, preferably between 70 and 500 nm, more preferably between 100 nm and 400 nm.

The polymerization reaction is carried out in batch at a temperature between 60° C. and 90° C. preferably between 70° C. and 85° C. at a solids concentration between 10 and 25 weight percent, preferably between 15 and 22 weight percent.

The polymerization reaction is initiated with at least one hydrophobic azo initiator, Illustrative examples of initiators include but are not limited to 2,2′Azobisisobutyronitrile, 2,2′-Azobis(4-methoxy-2,4-dimethylvaleronitrile), 2,2 -Azobis(2-methylpropionitrile, 2,2′-Azobis(2-methylbutironitrile), 1 1′-Azobis(cyclohexane-1-carbonitrile), or 1-(1-cyano-1-methyl ethyl)azo formamide. 2,2′Azobisisobutyronitrile is preferred.

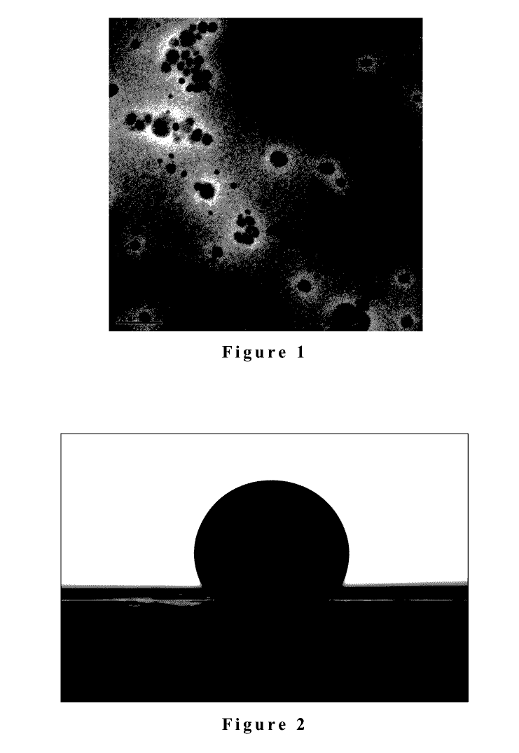

The initiator concentration used in the reaction is between 0.05 and 0.2 weight percent, preferably between 0.1 and 0.15 weight percent based on the total weight of the components of the emulsion. Complete conversion of monomers (>99%) for the polymerization reaction is obtained within 5 hours and 10 hours, preferably within 6 hours to 8 hours. The hybrid silicone latex resulting from the polymerization reaction is finely dispersed in the water phase with polymer particle sizes between 50 nm and 1000 nm, preferably between 50 nm and 300 nm as shown in FIG. 1.

In the second embodiment of the invention, a composition for a coating with a hydrophobic and easy cleaning effect containing the hybrid silicone latex, in accordance with the first embodiment, dispersed in water at a 0.5 to 15 weight percent concentration is described. This dispersion may be applied either by deposition, aspersion or spin coating over at least one surface, but not limited to concrete, glass or plaster and dried at standard pressure and humidity conditions at 40° C. for the formation of a hydrophobic, easy cleaning coating. The coatings obtained in this embodiment exhibit advancing contact angles between 95° and 110°. It is worth mentioning that in the present document we refer to composition to any dispersion of components or a mixture of them in water meanwhile we refer to coating as any composition being applied on a surface after evaporation of all volatile components.

Optionally a cosolvent can be used to improve film formation at room temperature. Examples of cosolvents but not limited to are ethyl acetate, ethanol, propanol, acetone, or mixtures thereof. The cosolvent can be incorporated in a proportion between 0.1 to 20 weight percent of all components of the mixture, preferably between 10 to 20 weight percent.

Optionally the hybrid silicone latex of the present invention can be blended with other commercially available acrylic emulsions, referred herein as standard emulsion, in a hybrid silicone latex/standard emulsion weight ratio of 1:5 to 99:1, preferably from 1:5 to 1:1. The coatings obtained with these mixtures show similar high hydrophobic properties as those observed when the hybrid silicone latex compositions described in the first embodiment are applied. The coatings obtained from these mixtures are transparent coatings with advancing angles between 90° and 106°. Depending on the glass transition temperature of the hybrid silicone latex and the standard emulsion, film formation can be optimized with the use of organic cosolvents such as, but not limited to, ethyl acetate, ethanol, propanol, acetone, or mixtures thereof. The cosolvent can be incorporated in a proportion between 0.1 and 20 weight percent of all components of the mixture, preferably between 10 and 20 weight percent. Furthermore, these cosolvents lower the surface tension of the total composition, improving the wettability properties of the substrate on which the composition is applied.

In a third embodiment of the invention a composition for coating with self-cleaning superhydrophobic effect is described. The composition contains a hybrid silicone latex, according to the first embodiment of the invention, and surface modified fumed silica nanoparticles by an organosilane. Fumed silica nanoparticles have a mean size between 15 and 200 nanometers, preferably between 20 and 100 nanometers; they have a surface area between 15 and 400 square meters/gram, more preferably between 35 and 300 square meters/gram, and even more preferably between 50 and 250 square meters/gram. Surface modification of fumed silica nanoparticles is carried out by silanol-silanol condensation reactions using hydrophobic alkoxysilanes, the free silanols on the surface of the nanoparticles are modified. The organosilane used has a vynilic, acrylic or methacrylic functionalization. Surface modification can be done with alkoxysilanes like, but not limited to the matter subject of the present application, vinyltrimethoxylsilane, vinyltriethoxysilane, 3-methacryloxypropyl methacrylate, 3-aminopropyl triethoxysilane, 3-acryloxypropyl methacrylate, vinyl-tris(2-methoxyethoxy) silane (Bourgeat-Lami, E. et al, Polymer, 36(23) p 4385-4389, 1995. Bourgeat-Lami, E. et al, Langmuir, 28 p 6021-6031, 2012. Hashemi-Nasab, R. et al Progress in Organic Coatings, 76 p 1016-1023, 2013). Functionalization percentage or surface modification is between 1.0 and 12.0 weight percent based on the total weight of the nanoparticles. Addition of surface modified nanoparticles is essential to obtain the super-hydrophobic effect.

An important characteristic of this embodiment of the invention is the use of the nanoparticles forming agglomerates to produce the required double scale roughness at the coating surface. This particulate agglomerates can have sizes from 30 and up to 10,000 nanometers, preferably between 50 and 5,000 nanometers, and more preferably between 100 and 2,000 nanometers. Surface modified nanoparticles concentration can be between 0.5 and 15 weight percent, preferably between 2.0 and 10.0 weight percent, based on the total weight of the coating composition that forms the super-hydrophobic, self-cleaning coating. In order to incorporate the nanoparticles into the composition, it is necessary to disperse them in water by the use of ultrasound.

Surface modified Nanoparticles dispersion stability is accomplished by using ionic and non-ionic surfactants, such as, but not limited to the matter subject of the present application, sodium dodecyl sulphate, sodium dodecylbencene sulphonate, nonylphenol ether ammonium salt or mixtures thereof.

The hybrid silicone latex in the third embodiment is present in a concentration between 0.5 and 15.0 weight percent, preferably between 2.0 and 10.0 weight percent based on the total weight of components in the coating composition for the super-hydrophobic self-cleaning coating. Composition, according to the third embodiment of the invention is applied on a solid substrate, like, but not limited to the matter subject of the present document, concrete, glass, plaster; by aspersion, spin coating or drop casting and dried at a temperature of 40° C. and standard pressure and humidity to form the super-hydrophobic, self-cleaning coating.

The coating obtained this way, has water contact angles over 130° and sliding angles lower than 20°.

### EXAMPLE 1

Eight different silicone-acrylic hybrid latexes were obtained by synthesis according with first embodiment of this invention, having polydimethylsiloxane/polybuthylmethacrylate weight ratios of 1:4, 2:3, 1:1 and 3:2 and two polydimethylsiloxane molecular weight macromonomers, 5,000 grams/mol (A, B, C and D) and 10,000 grams/mol (E, F, G and H). Each hybrid silicone latex was dispersed in water to 5 weight percent. Afterwards, each composition was applied by drop casting on glass substrate and dried at 40° C. over 8 hours. Water contact angles of resulting coatings are shown in table 1, and FIG. 2 shows a water drop on top of one of the coatings. Also, as a reference, water contact angle was measured for a pure polybuthylmethacrylate coating (latex 1).

TABLE 1
advancing and receding water contact angles for
coatings formed by the polydimethylsiloxane/
polybutylmethacrylate silicone hybrid latex.

| Latex | [symbol] _{A} | [symbol] _{R} | Latex | [symbol] _{A} | [symbol] _{R} |
|---|---|---|---|---|---|
| A | 100.0 ± 2.3 | 70.2 ± 1.0 | E | 107.1 ± 2.3 | 82.2 ± 1.8 |
| B | 101.3 ± 3.1 | 80.6 ± 0.4 | F | 106.6 ± 0.8 | 88.7 ± 3.3 |
| C | 106.5 ± 2.7 | 83.2 ± 2.0 | G | 105.5 ± 0.6 | 94.0 ± 1.4 |
| D | 101.6 ± 2.8 | 80.5 ± 4.3 | H | 103.4 ± 1.1 | 90.7 ± 1.4 |
| | | | I | 67.4 ± 2.5 | 51.2 ± 3.2 |

### EXAMPLE 2

The hybrid silicone latex G of example 1 was mixed with a standard acrylic emulsion at several weight ratios. The coatings formed from these compositions preserve the hydrophobicity and easy-to-clean properties of that of the pure hybrid silicone latex G of example 1 with only the 25 weight percent of the pure hybrid silicone latex G from the total solids of the composition. Table 2 reports the resulting water contact angles from these coatings.

TABLE 2
Advancing and receding water contact angles of
coatings from blends with different weight ratios of hybrid
silicone latex G and a 100% acrylic emulsion.

| ratio | [symbol] _{A} | [symbol] _{R} |
|---|---|---|
| 10/90 | 102.4 ± 3.2 | 64.6 ± 5.2 |
| 25/75 | 105.7 ± 1.5 | 80.0 ± 3.0 |
| 50/50 | 106.1 ± 1.9 | 89.1 ± 2.0 |

### EXAMPLE 3

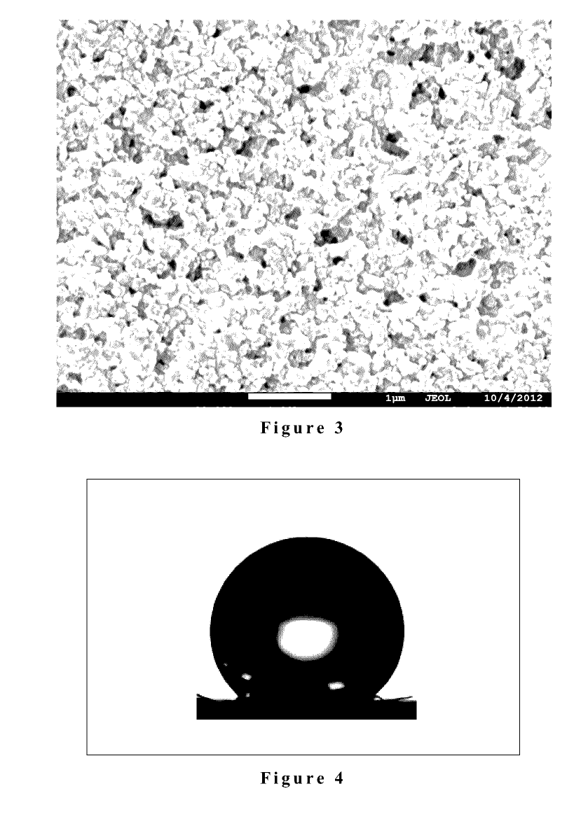

A composition containing nanoparticles with 10.2% vinyltrimethoxysilane surface modification dispersed in water, and the hybrid silicone latex G of example 1 was prepared. Concentrations are 5% of nanoparticles and 5% of latex G by weight based on the total weight of the composition. This composition also includes 20 weight percent of ethyl acetate as co-solvent from the total of the composition. Composition was homogenized using ultrasound shaker. It was applied on a substrate with low absorption and left drying for 24 hours at room temperature. Coatings obtained in this way presents a water contact angle of 142° and a sliding angle of 15°. Micro- and nano-roughness can be appreciated in FIG. 3. FIG. 4 shows a water drop on top of this coating.

The present invention has been described with particular reference to the preferred embodiments. It will be obvious to one of ordinary skill in the art that changes and modifications may be made to the above description without departing from the spirit and scope of the invention.

1. A hybrid silicone latex consisting of a methacrylic-polysiloxane copolymer with the general formula: 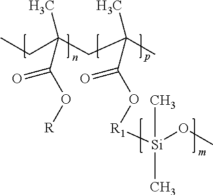
wherein R is either C1 to C4 alkyl chain or hydrogen and R₁ is either C2 to C4 alkyl chain.
Wherein the copolymer is obtained by the reaction of a reaction mixture comprising:
a) at least one partially water soluble methacrylic monomer with formula:
wherein R is either C₁ to C₄ alkyl chain or hydrogen; 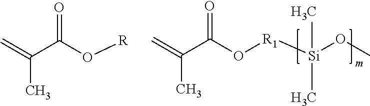
b) at least one water insoluble functionalized silicone macromonomer with formula:
wherein R₁ is either C₂ to C₄ alkyl chain.

2. The hybrid silicone latex according to claim 1, wherein the methacrylic monomer is selected from the group consisting of methylmethacrylate, buthylmethacrylate, methacrylic acid or mixtures thereof.

3. The hybrid silicone latex according to claim 1, wherein the functionalized silicone macromonomer is polydimethylsiloxane (PDMS).

4. The hybrid silicone latex according to claim 1, wherein the functionalized silicone macromonomer has a methacrylic functionality.

5. The hybrid silicone latex according to claim 1, wherein the functionalized silicone macromonomer has a molecular weight between 3,000 and 15,000 g/mol, preferably between 5,000 and 10,000 g/mol .

6. The hybrid silicone latex according to claim 1, wherein the methacrylic monomer is present in an amount between 8 and 18% by weight of the total reaction mixture.

7. The hybrid silicone latex according to claim 1, wherein the functionalized silicone macromonomer and the methacrylic monomer are present in a weight ratio of 1:9 to 7:3.

8. A method to obtain a hybrid silicone latex wherein comprises the steps of:
a) preparing a reaction mixture comprising:
i. water,
ii. at least one partially water soluble methacrylic monomer with formula:
wherein R is either C₁ to C₄ alkyl chain or hydrogen; 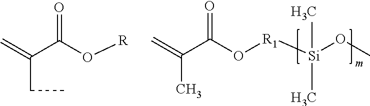
iii. at least one water insoluble functionalized silicone macromonomer with formula:
wherein R₁ is either C₂ to C₄ alkyl chain;
iv. at least one ionic or non-ionic emulsifier or mixtures thereof;
b) homogenizing with an ultrasound probe until an emulsion with droplet sizes between 50 and 1,000 nanometers, preferably 70 and 500 nanometers, and more preferably between 100 and 400 nanometers is reached;
c) to initiate a polymerization reaction with a least one hydrophobic initiator.

9. The method to obtain a hybrid silicone latex according to claim 8, wherein the polymerization reaction is carried out via miniemulsion polymerization without the use of cosolvents, stabilizing agents or hydrophobes.

10. The method to obtain a hybrid silicone latex according to claim 8, wherein the methacrylic monomer is selected from the group consisting of methylmethacrylate, buthylmethacrylate, methacrylic acid or mixtures thereof.

11. The method to obtain a hybrid silicone latex according to claim 8, wherein the functionalized silicone macromonomer is polydimethylsiloxane (PDMS).

12. The method to obtain a hybrid silicone latex according to claim 8, wherein the functionalized silicone macromonomer has a methacrylic functionality.

13. The method to obtain a hybrid silicone latex according to claim 8, wherein the methacrylic monomer is present in an amount of from 8 to 18% by weight of the total reaction mixture.

14. The method to obtain a hybrid silicone latex according to claim 8, wherein the functionalized silicone macromonomer and the methacrylic monomer are present in a weight ratio of 1:9 to 7:3.

15. The method to obtain a hybrid silicone latex according to claim 8, wherein the solids content of the reaction mixture is between 10.0 and 25.0% by weight.

16. The method to obtain a hybrid silicone latex according to claim 8, wherein the emulsifier is selected from the group consisting of sodium dodecyl sulphate, sodium dodecylbencene sulphonate, ammonium salt of nonylphenol ether or mixtures thereof.

17. The method to obtain a hybrid silicone latex according to claim 8, wherein the emulsifier is present in an amount of from 0.8 to 2.0%, preferably 1.0 to 1.5% by weight of the total components of the reaction mixture.

18. The method to obtain a hybrid silicone latex according to claim 8, wherein the hydrophobic initiator is an azo type.

19. The method to obtain a hybrid silicone latex according to claim 18, wherein the initiator is selected from the group consisting of 2,2′Azobis(isobutyronitrile), 2,2′-Azobis(4-methoxy-2,4-dimethylvaleronitrile), 2,2-Azobis(2-methylpropionitrile), 2,2′-Azobis(2 -methylbutyronitrile), 1,1′-Azobis(cyclohexane-l-carbonitrile) or 1-[(1-cyano-1-methylethyl)azo]formamide.

20. The method to obtain a hybrid silicone latex according to claim 8, wherein the initiator is present in an amount of from 0.05 to 0.2%, preferably 0.1 to 0.15% by weight of the total components of the reaction mixture.

21. The method to obtain a hybrid silicone latex according to claim 8, wherein the polymerization reaction is carried out in batch at a temperature between 60° C. and 90° C.

22. A method to obtain a hybrid silicone latex according to claim 8, wherein the polymerization reaction is carried out at a temperature between 70° C. and 85° C.

23. The method to obtain a hybrid silicone latex according to claim 8, wherein the polymerization reaction is carried out in a time interval between 5 and 10 hours, preferably between 6 and 8 hours.

24. A hydrophobic coating composition comprising:
a. water and
b. a hybrid silicone latex according to claim 1.

25. The hydrophobic coating composition according to claim 24, wherein the hybrid silicone latex is present in an amount of from 0.5 to 15.0% by weight of the total weight of the coating composition.

26. The hydrophobic coating composition according to claim 24, further comprising an organic cosolvent, wherein the organic cosolvent is present in an amount of from 0.1 and 20% by weight of the total coating composition.

27. The hydrophobic coating composition according to claim 26, wherein the organic cosolvent is selected from the group consisting of ethyl acetate, ethanol, propanol, acetone or mixtures thereof.

28. The hydrophobic coating composition according to claim 24, wherein the composition is applied by drop casting, aspersion or spin coating on concrete, glass or plaster to obtain a coating.

29. The hydrophobic coating composition according to claim 28, wherein the obtained coating exhibit advancing contact angles between 95° and 110°.

30. The hydrophobic coating composition according to claim 24, further comprising at least one standard emulsion.

31. The hydrophobic coating composition according to claim 30, wherein the standard emulsion is an acrylic emulsion.

32. The hydrophobic coating composition according to claim 30, wherein the hybrid silicone latex and the standard emulsion are present in a weight ratio of 1:5 to 99:1, preferably 1:5 to 1:1.

33. The hydrophobic coating composition according to claim 30, further comprising an organic cosolvent, wherein the organic cosolvent is present in an amount of from 0.1 to 20% by weight of the total coating composition.

34. The hydrophobic coating composition according to claim 33, wherein the organic cosolvent is selected from the group consisting of ethyl acetate, ethanol, propanol, acetone or mixtures thereof.

35. The hydrophobic coating composition according to claim 30, wherein the obtained coating exhibit advancing contact angles between 90° and 106°.

36. A super-hydrophobic coating composition comprising:
a. water
b. a hybrid silicone latex according to claim 1, and
c. fumed silica nanoparticles.

37. The super-hydrophobic coating composition according to claim 36, wherein the fumed silica nanoparticles have a mean size between 15 and 200 nanometers, preferably between 20 and 100 nanometers.

38. The super-hydrophobic coating composition according to claim 36, wherein the fumed silica nanoparticles are surface modified by an organosilane.

39. The super-hydrophobic coating composition according to claim 38, wherein the organosilane is an alkoxysilane.

40. The super-hydrophobic coating composition according to claim 39, wherein the alkoxysilane is selected from the group consisting of vinyltrimethoxylsilane, vinyltriethoxyl silane, 3-m ethacryloxypropyl methacrylate, 3-aminopropyltriethoxysilane, 3-acryloxypropyl methacrylate or vinyl-tris(2-methoxyethoxy) silane.

41. The super-hydrophobic coating composition according to claim 38, wherein the fumed silica nanoparticles are surface modified between 1.0 and 12.0% by weight of the total nanoparticles.

42. The super-hydrophobic coating composition according to claim 36 wherein the fumed silica nanoparticles are present in an amount of from 0.5 to 15.0, preferably 2.0 to 10.0% by weight of the total coating composition.

43. The super-hydrophobic coating composition according to claim 36, further comprising at least one ionic or non-ionic surfactant, or mixtures thereof.

44. The super-hydrophobic coating composition according to claim 43, wherein the ionic or non-ionic surfactant is selected from the group consisting of sodium dodecyl sulphate, sodium dodecylbencene sulphonate, nonylphenol ether ammonium salt or mixtures thereof.

45. The super-hydrophobic coating composition according to claim 36, wherein the hybrid silicone latex is present in an amount of from 0.5 to 15.0%, preferably 2.0 to 10.0% by weight of the total coating composition.

46. The super-hydrophobic coating composition according to claim 36, wherein the composition is applied by drop casting, aspersion or spin coating on concrete, glass or plaster to obtain a coating.

47. The super-hydrophobic coating composition according to claim 46, wherein the obtained coating exhibit water contact angles over 130° and sliding angles lower than 20°.
